(19) United States
(12) Patent Application Publication
(10) Pub. No.: US 2025/0330321 A1
(43) Pub. Date: Oct. 23, 2025

(54) PROVIDER UNIFIED MULTI-SERVICE NON-FUNGIBLE TOKEN AUTHENTICATION

(71) Applicant: TOKENFORM LLC, Denver, CO (US)

(72) Inventors: Jeffrey Binder, Denver, CO (US); Charles Hasek, Denver, CO (US); Lindsay Gardner, West Hollywood, CA (US)

(21) Appl. No.: 18/948,784

(22) Filed: Nov. 15, 2024

Related U.S. Application Data
(60) Provisional application No. 63/637,298, filed on Apr. 22, 2024.

(51) Int. Cl. H04L 9/32; G06Q 20/36

(52) U.S. Cl. CPC H04L 9/3213; G06Q 20/367

(57) ABSTRACT

Provider unified multi-service non-fungible token (NFT) authentication generates an NFT that may be used to authenticate to multiple services provided via a provider. This may add capabilities to that were not previously possible while improving operation of computer systems involved by reducing and/or eliminating consumption of the hardware and/or software resources that would have otherwise been used with the person providing dedicated authentication credentials for each of the multiple services, as well as tracking entitlement and billing for the multiple services as use of the NFT may enable tracking of entitlement and billing through the blockchain ledger associated with the NFT.

### CROSS-REFERENCE TO RELATED APPLICATION(S)

This application is a nonprovisional patent application of and claims the benefit under 35 U.S.C. § 119(e) of U.S. Provisional Patent Application No. 63/637,298, filed Apr. 22, 2024, and titled “Provider Unified Multi-Service Non-Fungible Token Authentication,” the contents of which are incorporated herein by reference in its entirety.

### FIELD

The described embodiments relate generally to authentication. More particularly, the present embodiments relate to provider unified multi-service non-fungible token authentication.

### BACKGROUND

A blockchain is a distributed ledger that is shared among nodes of a decentralized computer network. Blockchains are similar to databases in that they store information electronically in digital format. However, unlike a database, blockchains collect information together in groups, known as blocks. As blocks are filled they are closed, timestamped, and linked to a previously filled block. This data structure inherently makes an irreversible timeline of data when implemented in a decentralized nature.

One use of blockchains is to store non-fungible tokens (NFTs). NFTs are cryptographic assets on a blockchain with unique identification codes and metadata that distinguish them from each other. NFTs are typically used to represent rights to real world assets, such as artworks. NFTs are associated with a smart contract stored on the blockchain that controls transactions that can be performed with the NFTs and who can perform them. NFTs are accessible using private and/or public keys stored in a local and/or cloud-based token wallet assigned to the owner of the respective NFT, and ownership is tracked on the blockchain.

### OVERVIEW

The present disclosure relates to provider unified multi-service non-fungible token (NFT) authentication. An NFT may be generated that may be used to authenticate to multiple services provided via a provider. This may add capabilities to that were not previously possible while improving operation of computer systems involved by reducing and/or eliminating consumption of the hardware and/or software resources that would have otherwise been used with the person providing dedicated authentication credentials for each of the multiple services, as well as tracking entitlement and billing for the multiple services as use of the NFT may enable tracking of entitlement and billing through the blockchain ledger associated with the NFT.

In various embodiments, a system includes a non-transitory storage medium storing instructions and a processor. The processor executes the instructions to determine to generate a NFT for authenticating to multiple services, obtain user authentication credentials for a person associated with at least some of the multiple services, generate the NFT including the authentication credentials for at least some of the multiple services, and use the NFT to provide access to one of the multiple services.

In some examples, at least one of the authentication credentials includes login information. In a number of examples, the processor further executes the instructions to encrypt the user authentication credentials. In various examples, the processor further executes the instructions to obtain a public key associated with a service of the multiple services and encrypt information for the service of the multiple services in the NFT using the public key. In some examples, the processor uses the NFT to provide access to one of the multiple services by providing the NFT to the one of the multiple services.

In a number of examples, the processor uses the NFT to provide access to one of the multiple services by associating the NFT with a token wallet that is associated with the person. In various examples, the processor further executes the instructions to embed a link to a user authentication credential NFT in the NFT. In some examples, the processor further executes the instructions to embed a link to an entitlement system in the NFT. In a number of examples, the processor further executes the instructions to generate at least one of billing or entitlement information by analyzing a blockchain associated with the NFT.

In various examples, the processor further executes the instructions to embed entitlement information for one of the multiple services in the NFT. In some examples, the processor further executes the instructions to associate the NFT with a first electronic device, de-associate the NFT from the first electronic device, and associate the NFT with a second electronic device. In a number of examples, the one of the multiple services is a streaming service. In various examples, the multiple services are bundled services provided by a provider.

In some embodiments, a method includes determining to generate a NFT for authenticating to multiple services, generating the NFT, and using the NFT to provide access to one of the multiple services. In various examples, the NFT does not include user authentication credentials for at least some of the multiple services. In some examples, the method further includes obtaining authentication proof and allowing access to the NFT upon verifying the authentication proof.

In a number of embodiments, a computer program product includes first instructions stored in a non-transitory computer-readable medium and executable by at least one processing unit to determine to generate a non-fungible token (NFT) for authenticating to multiple services, second instructions stored in a non-transitory computer-readable medium and executable by at least one processing unit to obtain entitlement information for a person associated with at least some of the multiple services, third instructions stored in a non-transitory computer-readable medium and executable by at least one processing unit to generate the NFT based at least on the entitlement information, and fourth instructions stored in a non-transitory computer-readable medium and executable by at least one processing unit to provide access to the NFT.

In various examples, the NFT is usable to access the multiple services. In some examples, the computer program product further includes fourth instructions stored in a non-transitory computer-readable medium and executable by at least one processing unit to embed at least one limitation on at least one of the multiple services in the NFT. In a number of implementations of such examples, the at least one limitation is at least one of a geographic limitation, a number of streams limitation, or a number of households limitation.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example system.

FIG. 1B depicts a flow of using creation and minting of a smart contract and a non-fungible token. The flow may be performed by the system of FIG. 1A.

FIG. 1C depicts a list of backend services. The backend services may support and/or be provided by the system of FIG. 1A.

FIG. 1D depicts mint-print-manage functions. The mint-print-manage functions may be performed and/or supported and/or provided by the system of FIG. 1A.

FIG. 2 depicts a flow chart illustrating a first example method for performing provider unified multi-service non-fungible token authentication. This method may be performed by the system of FIG. 1A.

FIG. 3 depicts a flow chart illustrating a second example method for performing provider unified multi-service non-fungible token authentication. This method may be performed by the system of FIG. 1A.

FIG. 4 depicts a flow chart illustrating a third example method for performing provider unified multi-service non-fungible token authentication. This method may be performed by the system of FIG. 1A.

FIG. 5 depicts a flow chart illustrating a fourth example method for performing provider unified multi-service non-fungible token authentication. This method may be performed by the system of FIG. 1A.

FIG. 6 depicts a flow chart illustrating a fifth example method for performing provider unified multi-service non-fungible token authentication. This method may be performed by the system of FIG. 1A.

FIG. 7 depicts a flow chart illustrating a sixth example method for performing provider unified multi-service non-fungible token authentication. This method may be performed by the system of FIG. 1A.

FIG. 8 depicts a flow chart illustrating a seventh example method for performing provider unified multi-service non-fungible token authentication. This method may be performed by the system of FIG. 1A.

FIG. 9 depicts a flow chart illustrating an eighth example method for performing provider unified multi-service non-fungible token authentication. This method may be performed by the system of FIG. 1A.

FIG. 10 depicts a flow chart illustrating a ninth example method for performing provider unified multi-service non-fungible token authentication. This method may be performed by the system of FIG. 1A.

FIG. 11 depicts a flow chart illustrating a tenth example method for performing provider unified multi-service non-fungible token authentication. This method may be performed by the system of FIG. 1A.

FIG. 12 depicts a flow chart illustrating an eleventh example method for performing provider unified multi-service non-fungible token authentication. This method may be performed by the system of FIG. 1A.

FIG. 13 depicts a flow chart illustrating a twelfth example method for performing provider unified multi-service non-fungible token authentication. This method may be performed by the system of FIG. 1A.

FIG. 14 depicts example relationships among example components that may be used to implement the system of FIG. 1A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

There are many different services provided in the modern world. Examples of such services include broadcast television services, Internet services, streaming services, on demand programming services, and so on. In a number of situations, a provider may provide access to multiple other services, such as where a cable programming provider provides access to subscription channels in addition to broadcast television channels. Such a provider may bundle such multiple services in with the service that the provider provides such that an end user pays the provider and the provider passes on a portion of that payment to each of the multiple services.

Historically, cable programming providers established relationships with subscription channels and/or streaming services as part of a bundle with other services such that end users had no direct relationship with the subscription channels and/or streaming services. In such a scenario, it appeared to the end users as if the subscription channels and/or streaming services were just part of the cable programming provider service and the cable programming provider used proprietary entitlement and billing systems to track what end users had access to what, what was accessed and when, what monies were owed to whom, and so on.

However, streaming services and other providers of services provided via another provider such as cable programming began establishing direct relationships with end users such that end users had access credentials (such as a login and password) for the specific service. This may be the case even when the service was part of a bundle and the end user has no direct commercial relationship with the service. This technological implementation allows services to more closely track and target end users given that the service can directly identify what end user accesses what asset and when, but causes a number of other technological issues.

To begin with, end users may be bothered much more frequently with having to provide different credentials for different services instead of just being able to access services. This may consume hardware and/or software resources that would not otherwise be consumed, such as if they were eliminated by end users not needing to repeatedly provide different service credentials. Further, providing such credentials may often be additionally burdensome due to user interfaces, such as where a directional pad may be used to enter a login and password via a text selection menu that selects one character at a time.

Further, when there is a bundling relationship between a provider and multiple different services that each directly obtain unique credentials for end users (even when the end user uses the same credential, like a same login and password for multiple different services), the provider and the multiple different services may each store information in non-transitory storage media regarding billing, usage, entitlement, and so on and may need to communicate repeatedly over a network in order to coordinate such billing, usage, entitlement, and so on. As a result, this may also consume hardware and/or software resources that would not otherwise be consumed if redundant components and/or excessive network communication were eliminated.

These issues may be overcome by using a single non-fungible token (NFT) to authenticate to multiple services. In some examples, user authentication credentials for a person associated with at least some of the multiple services may be obtained and included in the NFT, whether encrypted (such as using a public key of a public/private key pair associate with one of the services to keep the information private from anyone not in possession of the private key) or not. In various examples, entitlement information for a person associated with at least some of the multiple services may be obtained and included in the NFT, whether encrypted or not. The NFT may be used to delegate authority using one or more techniques specified in application Ser. No. 18/221,620, which is incorporated by reference in its entirety. The NFT may also be involved in one or more directory services using one or more techniques specified in application Ser. No. 18/431,666, which is incorporated by reference in its entirety.

The present disclosure relates to provider unified multi-service NFT authentication. An NFT may be generated that may be used to authenticate to multiple services provided via a provider. This may add capabilities to that were not previously possible while improving operation of computer systems involved by reducing and/or eliminating consumption of the hardware and/or software resources that would have otherwise been used with the person providing dedicated authentication credentials for each of the multiple services, as well as tracking entitlement and billing for the multiple services as use of the NFT may enable tracking of entitlement and billing through the blockchain ledger associated with the NFT.

In this way, the present disclosure may provide technological solutions to the technological problems introduced by the multiple services establishing dedicated authentication credentials for end users. A system and/or device using the techniques of the present disclosure may be able to provide improved user interfaces, eliminate delays introduced by providing dedicated authentication credentials for each of the multiple services and/or tracking entitlement and billing for the multiple services, and/or perform various related functions that the system and/or device would not previously have been able to perform absent the technology disclosed herein. This may enable the system and/or device to operate more efficiently while consuming fewer hardware and/or software resources as more resource consuming techniques may be omitted. Further, one or more databases and/or other components (such as proprietary entitlement and/or billing systems) may be omitted while still enabling various functions and/or other functions, reducing unnecessary hardware and/or software components, and providing greater system flexibility and security.

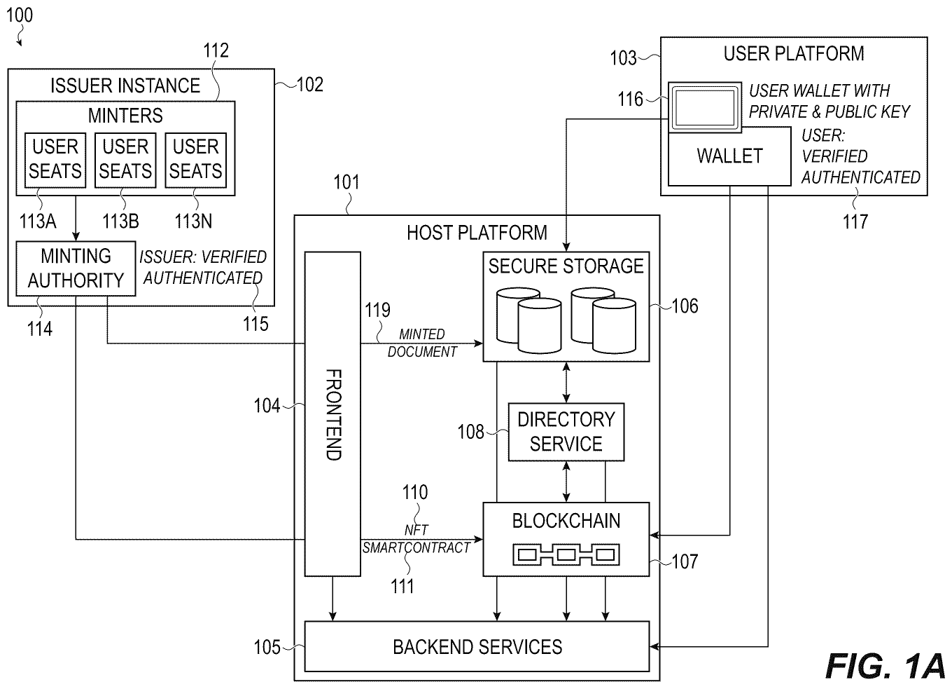

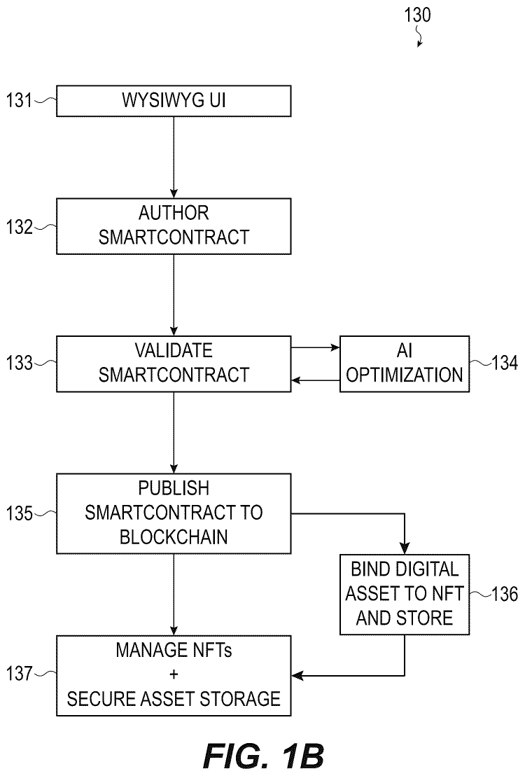

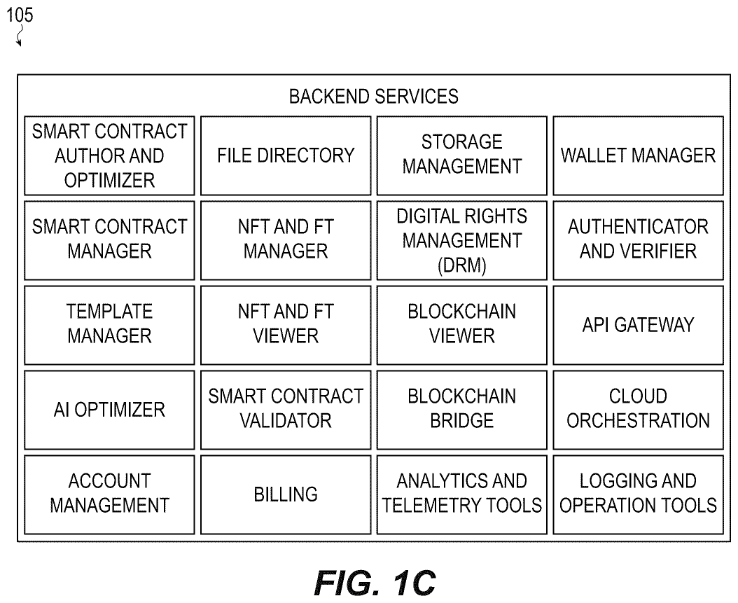

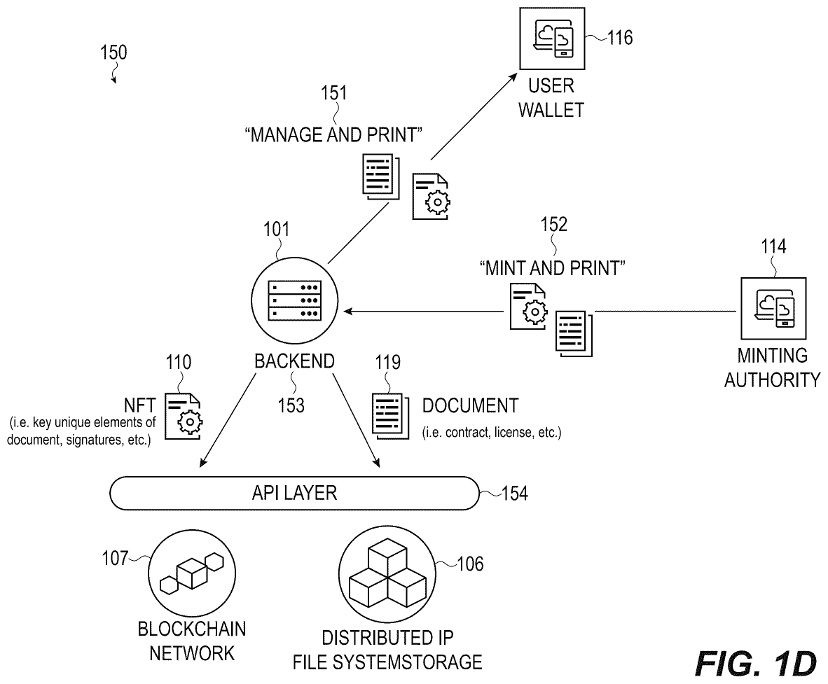

These and other embodiments are discussed below with reference to FIGS. 1A-14. However, those skilled in the art will readily appreciate that the detailed description given herein with respect to these Figures is for explanatory purposes only and should not be construed as limiting.

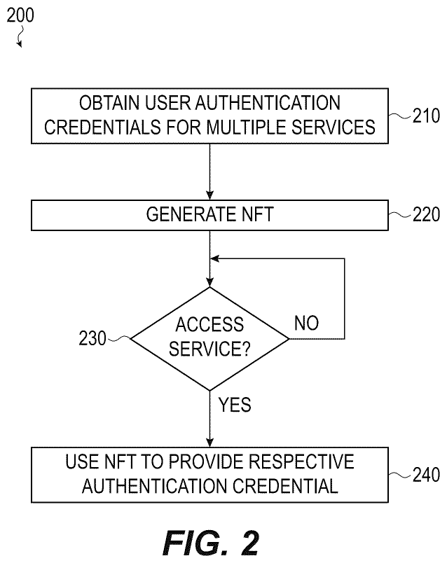

FIG. 1A depicts an example system 100. The system 100 (such as via a host platform 101) may perform various directory service functions. Examples of such operations are discussed in detail below with respect to FIGS. 2 and 4-13.

The system 100 may include a host platform 101 that is operable to create and/or perform one or more transactions and/or other actions related to one or more NFTs 110, smart contracts 111, and/or minted documents 119 on behalf of and/or for one or more other entities, such as one or more issuer instances 102, user platforms 103, intermediaries (not shown), and so on. Creation of the NFTs 110 may involve creation of one or more smart contracts 111, storage of the smart contracts 111 and/or the NFTs 110 in one or more blockchains, automatic creation and/or maintenance of one or more local and/or cloud-based token wallets (an electronic repository associated with storage of at least one or more private keys associated with one or more NFTs 110 and/or other tokens associated with one or more blockchains), and so on. In some cases, the private keys for the NFTs 110 and/or other encrypted and/or unencrypted data (such as one or more public keys, copies of the NFTs 110, payloads, and so on) may be stored in one or more local and/or cloud-based token wallets. The NFT document platform may also be operable to mint one or more documents, such as one or more birth certificates, contracts, and other signed documents, titles (such as house titles, car titles, and so on), prescriptions, licenses and/or identification documents, checks, money, gift cards, and so on. The smart contracts 111 and/or NFTs 110 may correspond to the one or more minted documents 119 and may even be created using data from and/or otherwise associated with the minted documents 119. The NFTs may be usable to authenticate the minted documents 119, evidence ownership of the minted documents 119, control the ability to perform transactions regarding the minted documents 119, and so on.

For example, the host platform 101 may generate a single non-fungible token (NFT) to authenticate to multiple services. In some examples, user authentication credentials for a person associated with at least some of the multiple services may be obtained and included in the NFT, whether encrypted (such as using an obtained public key of a public/private key pair associated with one of the services to keep the information private from anyone not in possession of the private key) or not. In various examples, entitlement information for a person associated with at least some of the multiple services may be obtained and included in the NFT, whether encrypted or not. The NFT may be used to delegate authority using one or more techniques specified in application Ser. No. 18/221,620, which is incorporated by reference in its entirety. The NFT may also be involved in one or more directory services using one or more techniques specified in application Ser. No. 18/431,666, which is incorporated by reference in its entirety. This may add capabilities to that were not previously possible while improving operation of computer systems involved by reducing and/or eliminating consumption of the hardware and/or software resources that would have otherwise been used with the person providing dedicated authentication credentials for each of the multiple services, as well as tracking entitlement and billing for the multiple services as use of the NFT may enable tracking of entitlement and billing through the blockchain ledger associated with the NFT.

In this way, technological solutions are provided to the technological problems introduced by the multiple services establishing dedicated authentication credentials for end users. The system 100 may be able to provide improved user interfaces, eliminate delays introduced by providing dedicated authentication credentials for each of the multiple services and/or tracking entitlement and billing for the multiple services, and/or perform various related functions that the system and/or device would not previously have been able to perform absent the technology disclosed herein. This may enable the system 100 to operate more efficiently while consuming fewer hardware and/or software resources as more resource consuming techniques may be omitted. Further, one or more databases and/or other components (such as proprietary entitlement and/or billing systems) may be omitted while still enabling various functions and/or other functions, reducing unnecessary hardware and/or software components, and providing greater system flexibility and security.

In some examples, the system 100 may determine to generate an NFT for authenticating to multiple services, obtain user authentication credentials for a person associated with at least some of the multiple services, generate the NFT including the authentication credentials for at least some of the multiple services, and use the NFT to provide access to one of the multiple services. In various examples, the system 100 may perform a method including determining to generate an NFT for authenticating to multiple services, generating the NFT, and using the NFT to provide access to one of the multiple services. In a number of examples, the system 100 may include first instructions stored in a non-transitory computer-readable medium and executable by at least one processing unit to determine to generate an NFT for authenticating to multiple services, second instructions stored in a non-transitory computer-readable medium and executable by at least one processing unit to obtain entitlement information for a person associated with at least some of the multiple services, third instructions stored in a non-transitory computer-readable medium and executable by at least one processing unit to generate the NFT based at least on the entitlement information, and fourth instructions stored in a non-transitory computer-readable medium and executable by at least one processing unit to provide access to the NFT.

The host platform 101 may include one or more frontends 104 and/or one or more backend services 105. The frontend 104 may include one or more application programming interfaces or “APIs”. Similarly, the backend services 105 may be accessed using one or more APIs. The frontend 104 may be usable by one or more issuer instances 102 to request creation of and/or performance of one or more transactions and/or other actions related to one or more NFTs 110, smart contracts 111, and/or minted documents 119. The frontend 104 may interact with one or more unsecure and/or secure storages 106 and/or one or more blockchains 107 to store one or more NFTs 110, smart contracts 111, minted documents 119, and so on. A directory service 108 may by usable by the host platform 101 to associate assets in the one more unsecure and/or secure storages 106 and/or one or more blockchains 107. The frontend 104 and/or the one or more blockchains 107 may be communicably connected to the backend services 105.

The issuer instance 102 may include one or more minters 112 that may include one or more user seats 113A-113N, a minting authority 114, an issuer 115, and so on. The issuer 115 may be verified and authenticated by the host platform 101, such as by communication over a verified connection, using multi-factor authentication (such as a login and/or password, a one-time password sent to a known email address and/or other communication address, one or more authenticator apps, and so on), and so on. The minting authority 114 and/or the issuer instance 102 may be communicably connected to the frontend 104.

The user platform 103 may include a user wallet 116 and a user 117. The user wallet 116 may be a token wallet. The user wallet 116 may store one or more private and/or public keys related to one or more NFTs. The user wallet 116 and/or the user platform 103 may be communicably connected to the one or more unsecure and/or secure storages 106, one or more blockchains 107, and/or backend services 105. The user 117 may be verified and authenticated by the host platform 101, such as by communication over a verified connection, using multi-factor authentication (such as a login and/or password, a one-time password (“OTP”) sent to a known email address and/or other communication address and/or to a device associated with an NFT, one or more authenticator apps, and so on), and so on.

FIG. 1B depicts a flow 130 of using creation and minting of a smart contract and non-fungible token. The flow may be performed by the system 100 of FIG. 1A. A what you see is what you get (“WYSIWYG”) and/or other user interface 131 may be provided. The user interface 131 may be used to author one or more smart contracts 132. The authored smart contracts may be validated 133 and/or optimized using artificial intelligence (AI) 134. The validated and/or optimized smart contract (and/or any generated related one or more NFTs) may be published to one or more blockchains 135. A digital asset related to the smart contract may be bound to the one or more NFTs and stored 136. The one or more NFTs may then be managed and the digital asset may be securely and/or otherwise stored 137.

Although the flow 130 illustrates a particular flow, it is understood that this is an example. In other implementations, other flows of the same, similar, and/or different operations may be used. Various configurations are possible and contemplated without departing from the scope of the present disclosure.

FIG. 1C depicts a list of backend services 105. The backend services 105 may support and/or be provided by the system 100 of FIG. 1A. The list may include one or more smart contract authors and/or optimizers, file directories, storage management, wallet managers, smart contract managers, NFT and FT managers, digital rights management (DRM), authenticators and/or verifiers, template managers, NFT and/or FT viewers, blockchain viewers, API gateways, AI optimizers, smart contract validators, blockchain bridges, cloud orchestration, account management, billing, analytics and/or telemetry tools, logging and operation tools, and so on.

Although the list illustrates examples of backend services 105, it is understood that this is an example. In other implementations, other backend services 105 may be used. Various configurations are possible and contemplated without departing from the scope of the present disclosure.

FIG. 1D depicts mint-print-manage functions 150. The mint-print-manage functions 150 may be performed and/or supported and/or provided by the system of FIG. 1A. As shown, a host platform 101 may communicate with a user wallet 116 and/or a minting authority 114 to perform manage and print functions 151 and/or mint and print functions 152. The host platform 101 may use a backend 153 and/or an API layer 154 to store one or more NFTs 110 (which may include key unique elements of one or more minted documents 119, signature, and so on) in one or more blockchain 107 networks and/or one or more minted documents 119 (such as one or more contracts, licenses, and so on) in a distributed internet protocol file system storage and/or other unsecure and/or secure storage 106.

Although the mint-print-manage functions 150 are illustrated and described with a particular configuration, it is understood that this is an example. In other implementations, other configurations of the same, similar, and/or different operations may be used. Various configurations are possible and contemplated without departing from the scope of the present disclosure.

Returning to FIG. 1A, although the system 100 is illustrated and described as including particular components arranged in a particular configuration, it is understood that this is an example. In a number of implementations, various configurations of various components may be used without departing from the scope of the present disclosure.

For example, the system 100 is illustrated and described as the user platform 103 including the user wallet 116. However, it is understood that this is an example. In various implementations, the system 100 may include a host platform 101 that automatically generates and/or maintains one or more local and/or cloud-based token wallets, such as token wallets associated with one or more communication addresses (such as one or more email addresses, telephone numbers, social media messaging addresses, and so on) of one or more users. This may increase the likelihood that users will use the system 100 as the users do not have to know how to create token wallets, as well as simplifying user interfaces and improving the operation of computing devices used to implement the system 100. Various configurations are possible and contemplated without departing from the scope of the present disclosure.

FIG. 2 depicts a flow chart illustrating a first example method 200 for performing provider unified multi-service non-fungible token authentication. This method may be performed by the system 100 of FIG. 1A.

At operation 210, an electronic device (such as one or more computing devices associated with the host platform 101 of FIG. 1A, the issuer instance 102 of FIG. 1A, the user platform 103 of FIG. 1A, and/or another device or system) may obtain user authentication credentials for multiple services. For example, the user authentication credentials may include a logins and passwords that a user has created for the multiple services. Alternatively and/or additionally, the user authentication credentials may include one or more NFTs. The user authentication credentials may be obtained from the user, from the multiple services, and so on. The electronic device may obtain the user authentication credentials after determining to generate an NFT for authenticating to the multiple services.

At operation 220, the electronic device may generate an NFT. The NFT may be used to access the multiple services. The NFT may include the user authentication credentials, an embedded link to the user authentication credentials, entitlement information for the user based on the user authentication credentials, a link to an entitlement system where entitlement information for the user may be obtained, a link via one or more directory services to one or more NFTs or other assets that include the user authentication credentials, and so on. Where the NFT includes such information, the information may be encrypted using the public key for a respective one of the multiple services of a public/private key pair (and/or hashed and/or otherwise obscured) such that only the respective one of the multiple services can access the information even if the NFT is provided to each of the multiple services.

At operation 230, the electronic device may determine whether or not a service (such as one of the multiple services) is accessed. If not, the flow may return to operation 230 where the electronic device may again determine whether or not a service is accessed. Otherwise, the flow may proceed to operation 240.

At operation 240, the electronic device may use the NFT to provide the respective authentication credential. For example, the electronic device may transmit the NFT to the respective service, indicate a token wallet associated with the user where the NFT is stored (which the electronic device may have stored the NFT and/or otherwise associated the NFT with after generating the NFT), and so on. The respective service may respond by allowing access based upon the authentication credential.

In this way, the NFT may reduce and/or eliminate the need for multiple sets of user authentication credentials, the need to repeatedly provide user authentication credentials, the need to share user authentication credentials, and so on.

For example, a person may wish to share streaming services with a babysitter while the babysitter is working at the person's house. The person may generate an NFT that expires when the babysitter will leave the person's house and is usable to authenticate to the various streaming services. The person may transfer the NFT to a device associated with the babysitter and. The babysitter may then make use of the NFT by providing a one time password that is sent to the device associated with the NFT in order to authenticate to the streaming services. Various configurations are possible and contemplated without departing from the scope of the present disclosure.

In various examples, this example method 200 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as obtaining user authentication credentials. However, it is understood that this is an example. In some implementations, the electronic device may instead obtain entitlement information that may be used to generate the NFT and the respective service may trust the entitlement information associated with the NFT based on a trusted relationship with the entity that generated the NFT. Various configurations are possible and contemplated without departing from the scope of the present disclosure.

In another example, a person may make use of an NFT that may be used to authenticate to multiple services by scanning a QR (quick response) code using a device associated with the NFT. This may enable authentication using an OTP that is sent out (such as to the device associated with the NFT), an authentication key included in the NFT, by communicating with an entitlement service that authenticates access based on the NFT or information included therein, and so on. Various configurations are possible and contemplated without departing from the scope of the present disclosure.

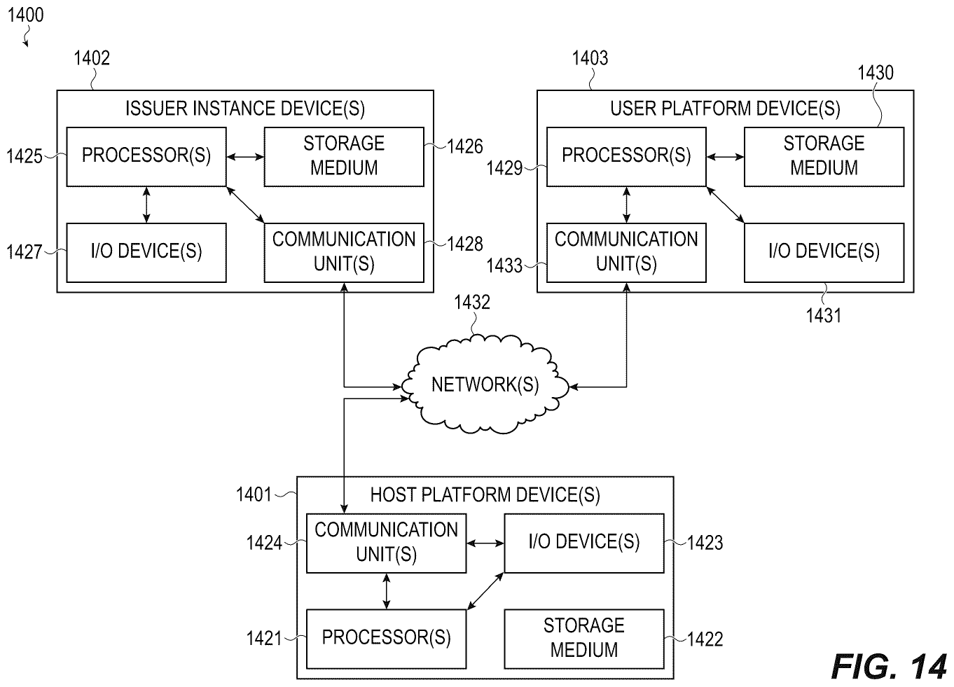

FIG. 14 depicts example relationships 1400 among example components that may be used to implement the system 100 of FIG. 1A.

The host platform 101 of FIG. 1 may be implemented using one or more host platform devices 1401. The host platform device 1401 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The host platform device 1401 may include one or more processors 1421 and/or other processing units and/or controllers, one or more non-transitory storage media 1422 (which may take the form of, but is not limited to, a magnetic storage medium; optical storage medium; magneto-optical storage medium; read only memory; random access memory; erasable programmable memory; flash memory; and so on), one or more communication units 1424 (such as one or more network adapters and/or other devices used by a device to communicate with one or more other devices), one or more input and/or output device(s) 1423 (such as one or more displays, speakers, touch screens, computer mice, track pads, keyboards, printers, and so on) and/or one or more other components. The processor 1421 may execute instructions stored in the non-transitory storage medium 1422 to perform various functions. Such functions may include any of the functions discussed herein with respect to the host platform 101 of FIG. 1A; communicating with one or more issuer instance devices 1402, user platform devices 1403, and/or one or more other devices via one or more wired and/or wireless networks 1432; and so on. Alternatively and/or additionally, the host platform device 1401 may involve one or more memory allocations configured to store at least one executable asset and one or more processor allocations configured to access the one or more memory allocations and execute the at least one executable asset to instantiate one or more processes and/or services, such as one or more host platform services, and so on.

Similarly, the issuer instance 102 of FIG. 1A may be implemented using one or more issuer instance devices 1402. The issuer instance device 1402 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The issuer instance device 1402 may include one or more processors 1425 and/or other processing units and/or controllers, one or more non-transitory storage media 1426 (which may take the form of, but is not limited to, a magnetic storage medium; optical storage medium; magneto-optical storage medium; read only memory; random access memory; erasable programmable memory; flash memory; and so on), one or more communication units 1428 (such as one or more network adapters and/or other devices used by a device to communicate with one or more other devices), one or more input and/or output device(s) 1427 (such as one or more displays, speakers, touch screens, computer mice, track pads, keyboards, printers, and so on) and/or one or more other components. The processor 1425 may execute instructions stored in the non-transitory storage medium 1426 to perform various functions. Such functions may include any of the functions discussed herein with respect to the issuer instance 102 of FIG. 1A; communicating with one or more host platform devices 1401, user platform devices 1403, and/or one or more other devices via one or more wired and/or wireless networks 1432; and so on. Alternatively and/or additionally, the issuer instance device 1402 may involve one or more memory allocations configured to store at least one executable asset and one or more processor allocations configured to access the one or more memory allocations and execute the at least one executable asset to instantiate one or more processes and/or services, such as one or more issuer instance services, and so on.

Likewise, the user platform 103 of FIG. 1A may be implemented using one or more user platform devices 1403. The user platform device 1403 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The user platform device 1403 may include one or more processors 1429 and/or other processing units and/or controllers, one or more non-transitory storage media 1430 (which may take the form of, but is not limited to, a magnetic storage medium; optical storage medium; magneto-optical storage medium; read only memory; random access memory; erasable programmable memory; flash memory; and so on), one or more communication units 1433 (such as one or more network adapters and/or other devices used by a device to communicate with one or more other devices), one or more input and/or output device(s) 1431 (such as one or more displays, speakers, touch screens, computer mice, track pads, keyboards, printers, and so on) and/or one or more other components. The processor 1429 may execute instructions stored in the non-transitory storage medium 1430 to perform various functions. Such functions may include any of the functions discussed herein with respect to the user platform 103 of FIG. 1A; communicating with one or more issuer instance devices 1402, host platform devices 1401, and/or one or more other devices via one or more wired and/or wireless networks 1432; and so on. Alternatively and/or additionally, the user platform device 1403 may involve one or more memory allocations configured to store at least one executable asset and one or more processor allocations configured to access the one or more memory allocations and execute the at least one executable asset to instantiate one or more processes and/or services, such as one or more user platform services, and so on.

Additionally, FIG. 1A may involve one or more other devices not shown. Such other devices may be any kind of electronic device. Examples of such other devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The other devices may include one or more processors and/or other processing units and/or controllers, one or more non-transitory storage media (which may take the form of, but is not limited to, a magnetic storage medium; optical storage medium; magneto-optical storage medium; read only memory; random access memory; erasable programmable memory; flash memory; and so on), one or more communication units (such as one or more network adapters and/or other devices used by a device to communicate with one or more other devices), one or more input and/or output components (such as one or more displays, speakers, touch screens, computer mice, track pads, keyboards, printers, and so on) and/or one or more other components. The processor may execute instructions stored in the non-transitory storage medium to perform various functions. Such functions may include any of the functions discussed herein; communicating with one or more issuer instance devices 1402, user platform devices 1403, host platform devices 1401, and/or one or more other devices via one or more wired and/or wireless networks 1432; and so on. Alternatively and/or additionally, the other devices may involve one or more memory allocations configured to store at least one executable asset and one or more processor allocations configured to access the one or more memory allocations and execute the at least one executable asset to instantiate one or more processes and/or services, such as one or more other device services, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices, and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first-or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

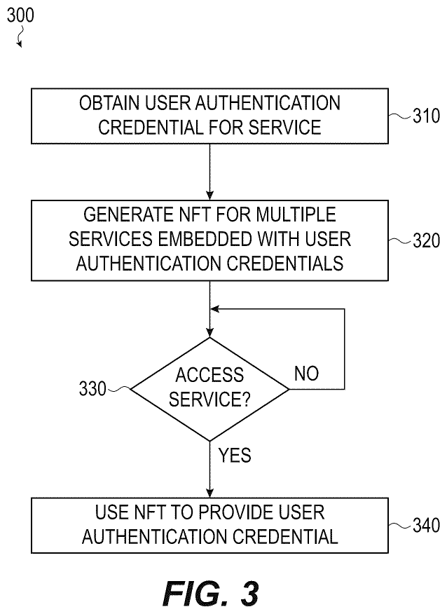

FIG. 3 depicts a flow chart illustrating a second example method 300 for performing provider unified multi-service non-fungible token authentication. This method 300 may be performed by the system 100 of FIG. 1A.

At operation 310, an electronic device (such as one or more computing devices associated with the host platform 101 of FIG. 1A, the issuer instance 102 of FIG. 1A, the user platform 103 of FIG. 1A, and/or another device or system) may obtain user authentication credential for service. The user authentication credentials may include login information, entitlement information, and so on.

At operation 320, the electronic device may generate NFT for multiple services embedded with the user authentication credentials. The embedded user authentication credentials may be encrypted.

At operation 330, the electronic device may determine whether or not a service is accessed. If not, the flow may return to operation 330 where the electronic device may again determine whether or not a service is accessed. Otherwise, the flow may proceed to operation 330.

At operation 340, the electronic device may use the NFT to provide the user authentication credential.

In various examples, this example method 300 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as embedding the user authentication credentials in the NFT. However, it is understood that this is an example. In some implementations, a link to the user authentication credentials may be embedded instead. In a number of implementations, the NFT may not include user authentication credentials for at least some of the multiple services, such as where those services trust the NFT itself as authentication due to a relationship with the entity that generated the NFT. Various configurations are possible and contemplated without departing from the scope of the present disclosure.

Additionally, by way of another example, in some implementations, other information may be embedded in the NFT. Such information may include at least one limitation on at least one of the multiple services. Such a limitation may include at least one of a geographic limitation (such as where the NFT is only usable in the United States), a number of steams limitation, a number of households limitation, and/or any other limitation on use of the NFT and/or the at least one of the multiple services. Various configurations are possible and contemplated without departing from the scope of the present disclosure.

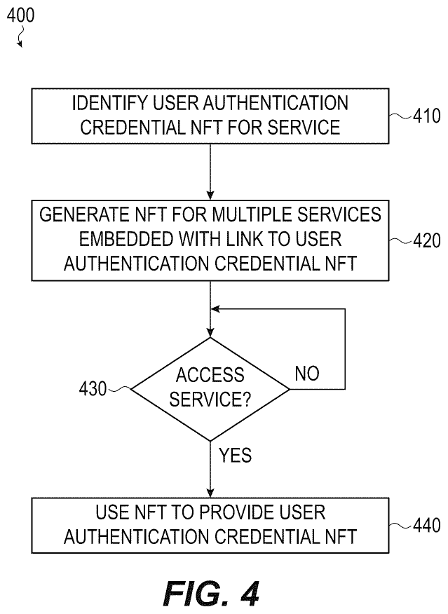

FIG. 4 depicts a flow chart illustrating a third example method 400 for performing provider unified multi-service non-fungible token authentication. This method 400 may be performed by the system 100 of FIG. 1A.

At operation 410, an electronic device (such as one or more computing devices associated with the host platform 101 of FIG. 1A, the issuer instance 102 of FIG. 1A, the user platform 103 of FIG. 1A, and/or another device or system) may identify a user authentication credential NFT for a service. The electronic device may identify the user authentication credential NFT for the service by prompting the user, by receiving information from the service, by analyzing a token wallet associated with the user, and so on.

At operation 420, the electronic device may generate an NFT for multiple services embedded with a link to the user authentication credential NFT. The link may make use of one or more directory services, which may be provided via one or more NFTs.

At operation 430, the electronic device may determine whether or not a service is accessed. If not, the flow may return to operation 430 where the electronic device may again determine whether or not a service is accessed. Otherwise, the flow may proceed to operation 440.

At operation 440, the electronic device may use the NFT to provide the user authentication credential NFT. The electronic device may use the NFT to provide the user authentication credential NFT by providing the NFT, by providing the link from the NFT, by associating the NFT with a token wallet, by indicating a token wallet associated with the NFT (such as a token wallet associated with the user, a token wallet associated with a specific electronic device (such as where the user may provide a login and password or other authentication proof to access an electronic device that has a token wallet associated (and thus access to the NFT) and then the user can access the multiple services via the electronic device but not another electronic device unless the NFT is de-associated with the token wallet associated with the electronic device and then associated with the token wallet of the other electronic device), or the like), and so on.

In various examples, this example method 400 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 is illustrated and described as identifying the user authentication credential NFT for the service. However, it is understood that this is an example. In some implementations, the method 400 may further include generating the user authentication credential NFT for the service. Various configurations are possible and contemplated without departing from the scope of the present disclosure.

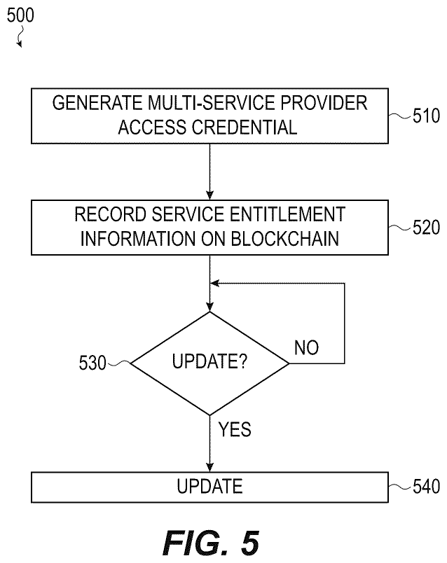

FIG. 5 depicts a flow chart illustrating a fourth example method 500 for performing provider unified multi-service non-fungible token authentication. This method 500 may be performed by the system 100 of FIG. 1A.

At operation 510, an electronic device (such as one or more computing devices associated with the host platform 101 of FIG. 1A, the issuer instance 102 of FIG. 1A, the user platform 103 of FIG. 1A, and/or another device or system) may generate a multi-service provider access credential NFT. The multi-service provider access credential NFT may be usable by a user to access multiple services.

At operation 520, the electronic device may record service entitlement information on one or more blockchains (and/or off chain associated with the one or more blockchains) associated with the multi-service provider access credential NFT. The entitlement information may specify one or more entitlements the user has with respect to one or more of the services.

At operation 530, the electronic device may determine whether or not to update. If not, the flow may return to operation 530 where the electronic device may again determine whether or not to update. Otherwise, the flow may proceed to operation 540.

At operation 540, the electronic device may update the entitlement information on the one or more blockchains. Updating may be performed in order to change service entitlement information for the person. For example, the user may be granted less or more service entitlement, service entitlement may expire or be renewed, and so on. Updating may reflect changes that have been made.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is described as determining whether or not to update. This may be performed at regular intervals, such as where a user has been granted access for 3 months and entitlement information does not need to be rechecked for those 3 months. However, it is understood that this is an example. In other implementations, entitlement information may be checked every time to ensure that no changes have been made, such as where a user purchased access for 3 months but cancelled a day later. Various configurations are possible and contemplated without departing from the scope of the present disclosure.

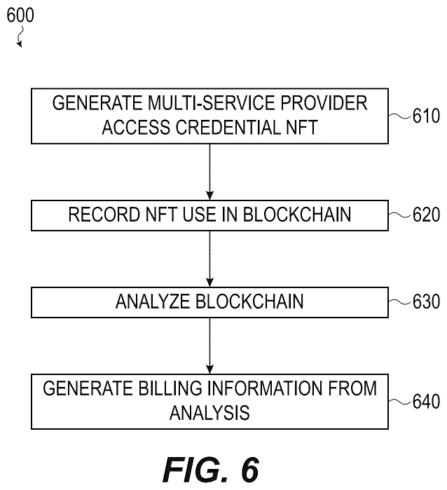

FIG. 6 depicts a flow chart illustrating a fifth example method 600 for performing provider unified multi-service non-fungible token authentication. This method 600 may be performed by the system 100 of FIG. 1A.

At operation 610, an electronic device (such as one or more computing devices associated with the host platform 101 of FIG. 1A, the issuer instance 102 of FIG. 1A, the user platform 103 of FIG. 1A, and/or another device or system) may generate a multi-service provider access credential NFT. At operation 620, the electronic device may record NFT use in blockchain. At operation 630, the electronic device may analyze the blockchain. At operation 640, the electronic device may generate billing information from the analysis.

Such billing information may be used for reconciliation and/or other accounting activities. This may eliminate the need for the proprietary billing system typically used by bundling service providers.

In various examples, this example method 600 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described in the context of billing information. However, it is understood that this is an example. In various implementations, the method 600 may be performed additionally or alternatively in the context of entitlement information. Various configurations are possible and contemplated without departing from the scope of the present disclosure.

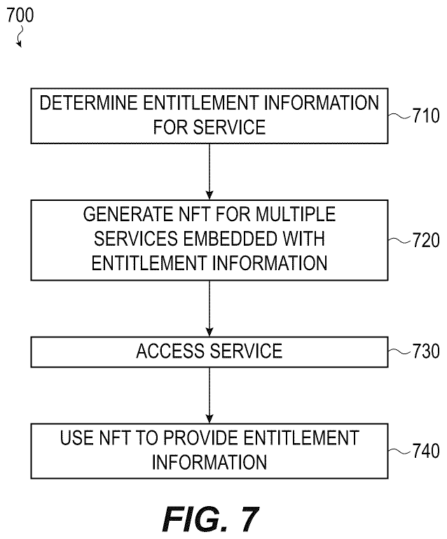

FIG. 7 depicts a flow chart illustrating a sixth example method 700 for performing provider unified multi-service non-fungible token authentication. This method 700 may be performed by the system 100 of FIG. 1A.

At operation 710, an electronic device (such as one or more computing devices associated with the host platform 101 of FIG. 1A, the issuer instance 102 of FIG. 1A, the user platform 103 of FIG. 1A, and/or another device or system) may determine entitlement information for one or more services. The entitlement information may be determined based on one or more agreements that a provider has with the one or more services.

At operation 720, the electronic device may generate an NFT for multiple services embedded with the entitlement information. Alternatively, the entitlement information may be recorded on a blockchain associated with the NFT.

At operation 730, the electronic device may determine whether or not to access a service. If not, the flow may return to operation 730 where the electronic device may again determine whether or not to access a service. Otherwise, the flow may proceed to operation 740.

At operation 740, the electronic device may use the NFT to provide the entitlement information. In this way, proprietary entitlement systems that are typically used may be eliminated. Similarly use of the NFT may enable elimination of proprietary authorization credentialling systems.

In various examples, this example method 700 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described in the context of entitlement information. However, it is understood that this is an example. In various implementations, the method 600 may be performed additionally or alternatively in the context of billing information. Various configurations are possible and contemplated without departing from the scope of the present disclosure.

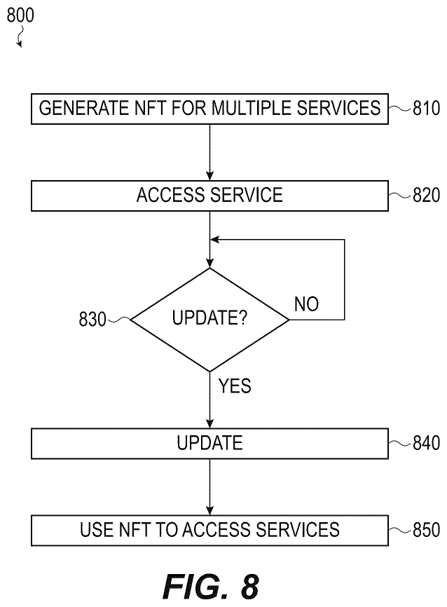

FIG. 8 depicts a flow chart illustrating a seventh example method 800 for performing provider unified multi-service non-fungible token authentication. This method 800 may be performed by the system 100 of FIG. 1A.

At operation 810, an electronic device (such as one or more computing devices associated with the host platform 101 of FIG. 1A, the issuer instance 102 of FIG. 1A, the user platform 103 of FIG. 1A, and/or another device or system) may generate an NFT for multiple services.

At operation 820, the electronic device may determine whether or not to access a service. If not, the flow may return to operation 820 where the electronic device may again determine whether or not to access a service. Otherwise, the flow may proceed to operation 850.

At operation 830, the electronic device may determine whether or not to update. The electronic device may determine to update based upon changes to entitlement information for a user that were used to generate the NFT. Updating may be performed in order to change entitlement information for the user. For example, the user may be granted less or more entitlement, entitlement may expire or be renewed, and so on. Updating may reflect changes that have been made. If not, the flow may return to operation 820 where the electronic device may determine whether or not to update. Otherwise, the flow may proceed to operation 840.

At operation 840, the electronic device may update. The flow may then return to operation 820 where the electronic device may determine whether or not to access a service.

At operation 850, the electronic device may use the NFT to access one or more of the services.

For example, the first version of the asset may be unavailable because the storage area where the first asset is stored may be overburdened or down. As such, providing the second version of the asset, which may be stored at another storage area, may provide redundancy and fault tolerance. Various configurations are possible and contemplated without departing from the scope of the present disclosure.

By way of another example, the first version of the asset may be unavailable because the requestor does not have authorization to access the storage area where the first asset is stored. This may be mitigated by providing the second version of the asset, which may be stored at a storage area that the requestor does have authorization to access. Various configurations are possible and contemplated without departing from the scope of the present disclosure.

In various examples, this example method 800 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 is described as first determining whether or not to access the service and then determining whether or not to update. However, it is understood that this is an example. In various implementations, such operations may be performed in a different order. Various configurations are possible and contemplated without departing from the scope of the present disclosure.

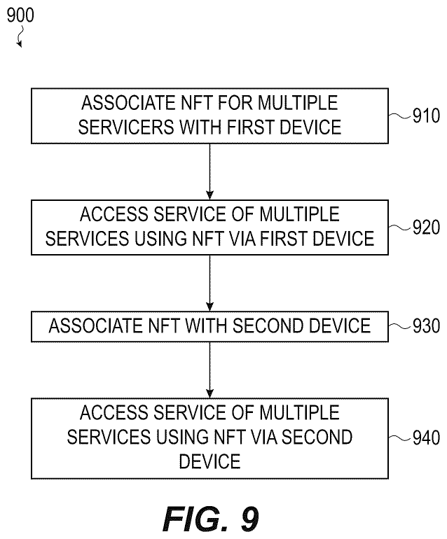

FIG. 9 depicts a flow chart illustrating an eight example method 900 for performing provider unified multi-service non-fungible token authentication. This method 900 may be performed by the system 100 of FIG. 1A.

At operation 910, an electronic device (such as one or more computing devices associated with the host platform 101 of FIG. 1A, the issuer instance 102 of FIG. 1A, the user platform 103 of FIG. 1A, and/or another device or system) may associate an NFT for multiple servicers with first device. For example, the first device may be a device that a user provides authentication proof (such as a login and password, biometric, an identified cable box authorized for use on a cable network, and so on) in order to access the device.

At operation 920, the electronic device may enable access one or more services of the multiple services using the NFT via the first device. The electronic device may enable access one or more services of the multiple services using the NFT via the first device by performing operations like informing a user that the user may access the one or more services via the first device.

For example, by virtue of having provided the authentication proof to access the first device, a user may use the first device to access one or more services of the multiple services because the NFT is associated with the first device. The user may not even be aware that the NFT exists or that the one or more services of the multiple services require authentication.

At operation 930, the electronic device may associate the NFT with a second device. As part of associating the NFT with a second device, the NFT may de-associate the NFT from the first electronic device.

At operation 940, the electronic device may enable access one or more services of multiple services using NFT via the second device. The electronic device may enable access one or more services of the multiple services using the NFT via the second device by performing operations like informing a user that the user may access the one or more services via the second device.

In various examples, this example method 900 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 is illustrated and described as the electronic device associating the NFT with the second device. However, it is understood that this is an example. In various implementations, such an operation may be performed by another device, such as the first device or the second device. Various configurations are possible and contemplated without departing from the scope of the present disclosure.

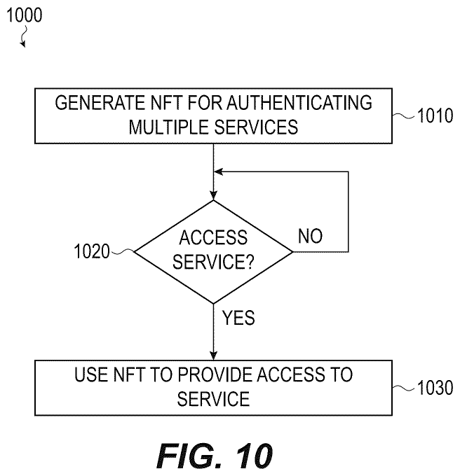

FIG. 10 depicts a flow chart illustrating a ninth example method 1000 for performing provider unified multi-service non-fungible token authentication. This method 1000 may be performed by the system 100 of FIG. 1A.

At operation 1010, an electronic device (such as one or more computing devices associated with the host platform 101 of FIG. 1A, the issuer instance 102 of FIG. 1A, the user platform 103 of FIG. 1A, and/or another device or system) may generate an NFT for authenticating to multiple services.

At operation 1020, the electronic device may determine whether or not to access a service of the multiple services. If not, the flow may return to operation 1020 where the electronic device may again determine whether or not to access a service. Otherwise, the flow may proceed to operation 1030.

At operation 1030, the electronic device may use the NFT to provide access to the service.

In various examples, this example method 1000 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described as having the same electronic device generate the NFT, determine whether or not to access the service, and use the NFT to provide access to the service. However, it is understood that this is an example. In various implementations, one or more of these operations may be performed by one or more different electronic devices. Various configurations are possible and contemplated without departing from the scope of the present disclosure.

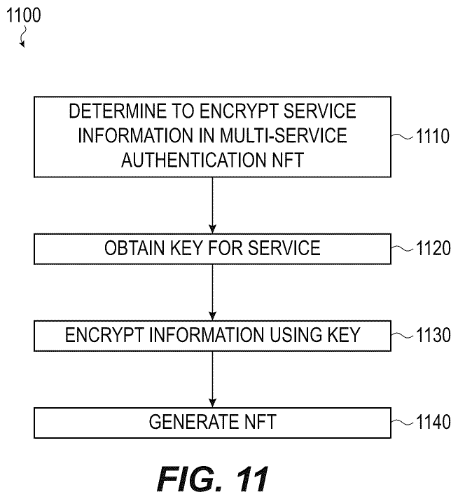

FIG. 11 depicts a flow chart illustrating a tenth example method 1100 for performing provider unified multi-service non-fungible token authentication. This method 1100 may be performed by the system 100 of FIG. 1A.

At operation 1110, an electronic device (such as one or more computing devices associated with the host platform 101 of FIG. 1A, the issuer instance 102 of FIG. 1A, the user platform 103 of FIG. 1A, and/or another device or system) may determine to encrypt service information for a service of multiple services in a multi-service authentication NFT. The service information may be entitlement information, billing information, authentication information, and so on.

At operation 1120, the electronic device may obtain a key for the service. The key may be a public key or a public/private key pair associated with the service.

At operation 1130, the electronic device may encrypt the information using the key.

At operation 1140, the electronic device may generate the NFT. The encrypted information may be included in the NFT, linked to on or off the blockchain associated with the NFT by one or more links in the NFT and/or directory services associated with the NFT, and so on.

In various examples, this example method 1100 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1100 is illustrated and described as including particular operations performed in a particular order, it is understood that this is an example. In various implementations, various orders of the same, similar, and/or different operations may be performed without departing from the scope of the present disclosure.

For example, the method 1100 is illustrated and described as obtaining a key for the service. However, it is understood that this is an example. In various implementations, the electronic device may generate an encryption key to use for the service and then transmit an associated decryption key to the service. Various configurations are possible and contemplated without departing from the scope of the present disclosure.

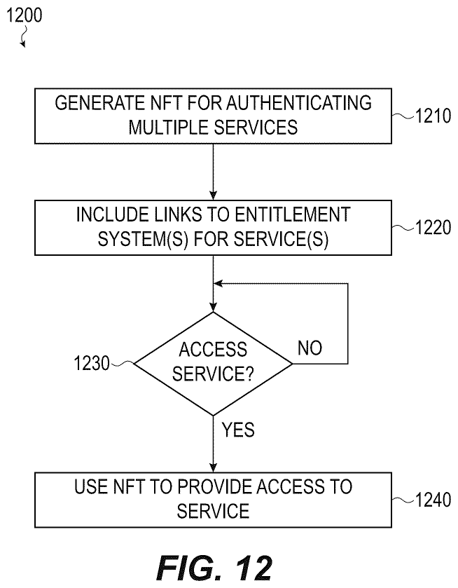

FIG. 12 depicts a flow chart illustrating an eleventh example method 1200 for performing provider unified multi-service non-fungible token authentication. This method 1200 may be performed by the system 100 of FIG. 1A.

At operation 1210, an electronic device (such as one or more computing devices associated with the host platform 101 of FIG. 1A, the issuer instance 102 of FIG. 1A, the user platform 103 of FIG. 1A, and/or another device or system) may generate an NFT for authenticating to multiple services.

At operation 1220, the electronic device may include links to one or more entitlement systems for one or more services of the multiple services. The links may be usable to access entitlement information for a user with respect to one or more of the multiple services.

At operation 1230, the electronic device may determine whether or not to access a service. If not, the flow may return to operation 1230 where the electronic device may again determine whether or not to access a service. Otherwise, the flow may proceed to operation 1240.

At operation 1240, the electronic device may use the NFT to provide access to the service.

In various examples, this example method 1200 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1200 is illustrated and described as including particular operations performed in a particular order, it is understood that this is an example. In various implementations, various orders of the same, similar, and/or different operations may be performed without departing from the scope of the present disclosure.

For example, the method 1200 is illustrated and described as using links to the one or more entitlement systems. However, it is understood that this is an example. In various implementations, mechanisms other than links may be used to access entitlement information stored in one or more entitlement systems, such as one or more entitlement system identifiers associated with a user. Various configurations are possible and contemplated without departing from the scope of the present disclosure.

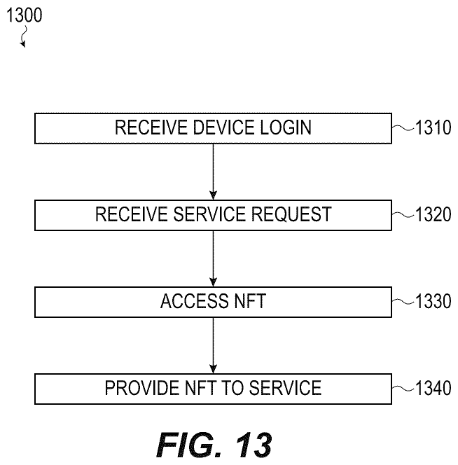

FIG. 13 depicts a flow chart illustrating a twelfth example method 1300 for performing provider unified multi-service non-fungible token authentication. This method 1300 may be performed by the system 100 of FIG. 1A.

At operation 1310, an electronic device (such as one or more computing devices associated with the host platform 101 of FIG. 1A, the issuer instance 102 of FIG. 1A, the user platform 103 of FIG. 1A, and/or another device or system) may receive a device login. The electronic device may provide access to the electronic device in response to the device login.

At operation 1320, the electronic device may receive a service request. The service request may be for a service of multiple services accessible via the electronic device.

At operation 1330, the electronic device may access an NFT. The NFT may be usable to access multiple services. The NFT may be provided to the electronic device, associated with a token wallet associated with a requestor and/or the electronic device, and so on.

At operation 1340, the electronic device may provide the NFT to the service.

In various examples, this example method 1300 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1300 is illustrated and described as including particular operations performed in a particular order, it is understood that this is an example. In various implementations, various orders of the same, similar, and/or different operations may be performed without departing from the scope of the present disclosure.

For example, the method 1300 is illustrated and described as the electronic device providing the NFT to the service. However, it is understood that this is an example. In various implementations, the service may detect that the NFT is associated with a token wallet associated with the user or the electronic device and the electronic device may omit providing the NFT to the service. Various configurations are possible and contemplated without departing from the scope of the present disclosure.

In various implementations, a system may include a non-transitory storage medium storing instructions and a processor. The processor may execute the instructions to determine to generate a NFT for authenticating to multiple services, obtain user authentication credentials for a person associated with at least some of the multiple services, generate the NFT including the authentication credentials for at least some of the multiple services, and use the NFT to provide access to one of the multiple services.

In some examples, at least one of the authentication credentials may include login information. In a number of examples, the processor may further execute the instructions to encrypt the user authentication credentials. In various examples, the processor may further execute the instructions to obtain a public key associated with a service of the multiple services and encrypt information for the service of the multiple services in the NFT using the public key. In some examples, the processor may use the NFT to provide access to one of the multiple services by providing the NFT to the one of the multiple services.

In a number of examples, the processor may use the NFT to provide access to one of the multiple services by associating the NFT with a token wallet that is associated with the person. In various examples, the processor may further execute the instructions to embed a link to a user authentication credential NFT in the NFT. In some examples, the processor may further execute the instructions to embed a link to an entitlement system in the NFT. In a number of examples, the processor may further execute the instructions to generate at least one of billing or entitlement information by analyzing a blockchain associated with the NFT.

In various examples, the processor may further execute the instructions to embed entitlement information for one of the multiple services in the NFT. In some examples, the processor may further execute the instructions to associate the NFT with a first electronic device, de-associate the NFT from the first electronic device, and associate the NFT with a second electronic device. In a number of examples, the one of the multiple services may be a streaming service. In various examples, the multiple services may be bundled services provided by a provider.

In some implementations, a method may include determining to generate a NFT for authenticating to multiple services, generating the NFT, and using the NFT to provide access to one of the multiple services. In various examples, the NFT may not include user authentication credentials for at least some of the multiple services. In some examples, the method may further include obtaining authentication proof and allowing access to the NFT upon verifying the authentication proof.

In a number of implementations, a computer program product may include first instructions stored in a non-transitory computer-readable medium and executable by at least one processing unit to determine to generate a non-fungible token (NFT) for authenticating to multiple services, second instructions stored in a non-transitory computer-readable medium and executable by at least one processing unit to obtain entitlement information for a person associated with at least some of the multiple services, third instructions stored in a non-transitory computer-readable medium and executable by at least one processing unit to generate the NFT based at least on the entitlement information, and fourth instructions stored in a non-transitory computer-readable medium and executable by at least one processing unit to provide access to the NFT.

In various examples, the NFT may be usable to access the multiple services. In some examples, the computer program product may further include fourth instructions stored in a non-transitory computer-readable medium and executable by at least one processing unit to embed at least one limitation on at least one of the multiple services in the NFT. In a number of such examples, the at least one limitation may be at least one of a geographic limitation, a number of streams limitation, or a number of households limitation.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to provider unified multi-service NFT authentication. An NFT may be generated that may be used to authenticate to multiple services provided via a provider. This may add capabilities to that were not previously possible while improving operation of computer systems involved by reducing and/or eliminating consumption of the hardware and/or software resources that would have otherwise been used with the person providing dedicated authentication credentials for each of the multiple services, as well as tracking entitlement and billing for the multiple services as use of the NFT may enable tracking of entitlement and billing through the blockchain ledger associated with the NFT.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system, comprising:
a non-transitory storage medium storing instructions; and
a processor that executes the instructions to:
determine to generate a non-fungible token (NFT) for authenticating to multiple services;
obtain user authentication credentials for a person associated with at least some of the multiple services;
generate the NFT including the authentication credentials for at least some of the multiple services; and
use the NFT to provide access to one of the multiple services.

2. The system of claim 1, wherein at least one of the authentication credentials includes login information.

3. The system of claim 1, wherein the processor further executes the instructions to encrypt the user authentication credentials.

4. The system of claim 1, wherein the processor further executes the instructions to:
obtain a public key associated with a service of the multiple services; and
encrypt information for the service of the multiple services in the NFT using the public key.

5. The system of claim 1, wherein the processor uses the NFT to provide access to one of the multiple services by providing the NFT to the one of the multiple services.

6. The system of claim 1, wherein the processor uses the NFT to provide access to one of the multiple services by associating the NFT with a token wallet that is associated with the person.

7. The system of claim 1, wherein the processor further executes the instructions to embed a link to a user authentication credential NFT in the NFT.

8. The system of claim 1, wherein the processor further executes the instructions to embed a link to an entitlement system in the NFT.

9. The system of claim 1, wherein the processor further executes the instructions to generate at least one of billing or entitlement information by analyzing a blockchain associated with the NFT.

10. The system of claim 1, wherein the processor further executes the instructions to embed entitlement information for one of the multiple services in the NFT.

11. The system of claim 1, wherein the processor further executes the instructions to:
associate the NFT with a first electronic device;
de-associate the NFT from the first electronic device; and
associate the NFT with a second electronic device.

12. The system of claim 1, wherein the one of the multiple services comprises a streaming service.

13. The system of claim 1, wherein the multiple services comprises bundled services provided by a provider.

14. A method, comprising:
determining to generate a non-fungible token (NFT) for authenticating to multiple services;
generating the NFT; and
using the NFT to provide access to one of the multiple services.

15. The method of claim 14, wherein the NFT does not include user authentication credentials for at least some of the multiple services.

16. The method of claim 14, further comprising:
obtaining authentication proof; and
allowing access to the NFT upon verifying the authentication proof.

17. A computer program product, comprising:
first instructions stored in a non-transitory computer-readable medium and executable by at least one processing unit to determine to generate a non-fungible token (NFT) for authenticating to multiple services;
second instructions stored in a non-transitory computer-readable medium and executable by at least one processing unit to obtain entitlement information for a person associated with at least some of the multiple services;
third instructions stored in a non-transitory computer-readable medium and executable by at least one processing unit to generate the NFT based at least on the entitlement information; and
fourth instructions stored in a non-transitory computer-readable medium and executable by at least one processing unit to provide access to the NFT.

18. The computer program product of claim 17, wherein the NFT is usable to access the multiple services.

19. The computer program product of claim 17, further comprising fourth instructions stored in a non-transitory computer-readable medium and executable by at least one processing unit to embed at least one limitation on at least one of the multiple services in the NFT.

20. The computer program product of claim 19, wherein the at least one limitation comprises at least one of a geographic limitation, a number of streams limitation, or a number of households limitation.
